(19) United States
(12) Patent Application Publication
(10) Pub. No.: US 2026/0332264 A1
(43) Pub. Date: Oct. 22, 2026

(54) OPTICAL INTERCONNECTION DEVICE AND MANUFACTURING METHOD THEREFOR, AND CHIP PACKAGE

(71) Applicant: HANGZHOU GUANGZHIYUAN TECHNOLOGY CO., LTD., Hangzhou, Zhejiang (CN)

(72) Inventors: Huaiyu MENG, Hangzhou, Zhejiang (CN); Yichen SHEN, Hangzhou, Zhejiang (CN)

(73) Assignee: HANGZHOU GUANGZHIYUAN TECHNOLOGY CO., LTD., Hangzhou, Zhejiang (CN)

(21) Appl. No.: 19/099,453

(22) PCT Filed: Aug. 1, 2023
(86) PCT No.: PCT/CN2023/110575

§ 371 Date: Jan. 28, 2025

(30) Foreign Application Priority Data
Aug. 1, 2022 (CN) 202210917110.9

(51) Int. Cl. H04B 10/275; G02B 6/42; H04B 10/27

(52) U.S. Cl. CPC H04B 10/275; G02B 6/4257; H04B 10/271

(57) ABSTRACT

The disclosure relates to optical interconnection, and provides an optical interconnection device (100), a manufacturing method thereof, and a chip package. The optical interconnection device (100) includes at least four nodes (101), wherein each node (101) is configured to communicate with an external device; and a plurality of waveguides, wherein each waveguide is configured to optically connect two of the at least four nodes (101). The chip package includes the optical interconnect device (100) and at least four chips. The method for manufacturing the optical interconnect device (100) is provided.

This application claims priority to Chinese Patent Application No. 202210917110.9 filed with CNIPA on Aug. 1, 2022, and entitled “OPTICAL INTERCONNECTION DEVICE AND MANUFACTURING METHOD THEREFOR, AND CHIP PACKAGING”. The disclosure of the aforementioned application is incorporated herein by reference in its entirety.

### TECHNICAL FIELD

The present application relates to the field of optical interconnection, and more specifically, to an optical interconnection device, a manufacturing method for the optical interconnection device, and a chip package.

### BACKGROUND

Within chips and chip packages, traditional information transmission primarily relies on electronic transmission through copper media. However, the speed and distance of electronic information transmission are limited by the resistor-capacitor (RC) time constant as well as electrical loss. As a result, a diameter of a required copper wire significantly increases with the increasing transmission speeds distances. Additionally, such an electrical signal interconnection further has signal crosstalk and bandwidth constraints.

Optical signals have been employed for data transmission over both long distances and some short distances, including data transmission within data centers and within individual devices. An example of an optical network for data transmission within a device is an Optical Network on a Chip (ONoC). ONoC often requires complex waveguide designs to achieve optical interconnection between nodes. For example, to achieve the optical interconnection, waveguides may need to be arranged in multiple layers to avoid intersections between the waveguides. Such complex waveguide designs not only limit the integration of the device, but also increases production costs.

### TECHNICAL SOLUTIONS

In order to solve at least one of the above technical problems, the present disclosure provides an optical interconnection device, a manufacturing method thereof, and a chip package. The adopted technical solutions are as follows.

In a first aspect, the present disclosure provides an optical interconnection device, including:
at least four nodes, wherein each node is configured to communicate with an external device; and
a plurality of waveguides, wherein each waveguide is configured to optically connect two of the at least four nodes.

In some embodiments, the plurality of waveguides are arranged along a virtual closed path passing through the at least four nodes, such that the plurality of waveguides do not cross each other.

In some embodiments, each node includes at least one of one or more optical transmitting portions and one or more optical receiving portions. Each waveguide is configured to connect one of the one or more optical transmitting portions of one of the at least four nodes to one of the one or more optical receiving portions of another of the at least four nodes, so as to transmit an optical signal from the optical transmitting portion of the one node to the optical receiving portion of the another node.

In some embodiments, the at least four nodes include a first node and a second node, and the plurality of waveguides includes a waveguide for connecting the first node and the second node.

In some embodiments, along the virtual closed path, the first node is adjacent to the second node. In some embodiments, along the virtual closed path, there are N other nodes of the at least four nodes between the first node and the second node, wherein N≥1.

In some embodiments, along the virtual closed path, the at least four nodes include consecutively adjacent first node, second node, third node, and fourth node. The plurality of waveguides include a waveguide connecting the first node to the second node, a waveguide connecting the first node to the third node, and a waveguide connecting the first node to the fourth node.

In some embodiments, along the virtual closed path, the at least four nodes include consecutively adjacent first node, second node, third node, and fourth node. The plurality of waveguides include a waveguide connecting the first node to the third node, and a waveguide connecting the second node to the fourth node.

In some embodiments, along the virtual closed path, the at least four nodes include consecutively adjacent first node, second node, third node, and fourth node. The plurality of waveguides include a waveguide connecting the first node to the fourth node, and a waveguide connecting the second node to the third node.

In some embodiments, along the virtual closed path, the at least four nodes include consecutively adjacent first node, second node, third node, fourth node, and fifth node. The plurality of waveguides include a waveguide connecting the first node to the fourth node, and a waveguide connecting the second node to the fifth node.

In some embodiments, the at least four nodes include a starting node, and the plurality of waveguides are configured to connect the starting node to each of other nodes of the at least four nodes. In some embodiments, the starting node includes the optical transmitting portions, which are respectively connected to a corresponding one of the one or more optical receiving portions of each of the other nodes through different ones of the plurality of waveguides along the virtual closed path in a same direction. In some embodiments, the starting node includes the optical transmitting portions, some of which are respectively connected to a corresponding one of the one or more optical receiving portions of each of some of the other nodes through different ones of the plurality of waveguides along the virtual closed path in a first direction, and remaining of which are connected to a corresponding one of the one or more optical receiving portions of each of remaining nodes of the other nodes through other different ones of the plurality of waveguides along the virtual closed path in a second direction, wherein the second direction is opposite to the first direction.

In some embodiments, the at least four nodes are arranged in an array, the virtual closed path extends along columns or rows of the array, and the plurality of waveguides are arranged along the virtual closed path.

In some embodiments, each of the at least four nodes is configured to be connected to a second neighbouring adjacent node thereof.

In some embodiments, each node includes at least one of one or more optical transmitting portions and one or more optical receiving portions.

In some embodiments, each waveguide is configured to connect a corresponding one of the one or more optical transmitting portions of one of the at least four nodes to a corresponding one of the one or more optical receiving portions of another of the at least four nodes, so as to transmit an optical signal from the optical transmitting portion of the one node to the optical receiving portion of the another node.

In some embodiments, each optical transmitting portion includes an electro-optical conversion unit, and each optical receiving portion includes a photoelectric conversion unit.

In some embodiments, the plurality of waveguides include a curved waveguide.

In some embodiments, the plurality of waveguides are configured such that any two of the at least four nodes are connected.

In a second aspect, the present disclosure further provides a chip package, including:
the optical interconnection device as described in any one of the above embodiments; and
at least four chips, wherein each chip is coupled to a corresponding one of the at least four nodes of the optical interconnection device, and the at least four chips and the at least four nodes have a one-to-one correspondence,
wherein the optical interconnection device is configured to enable communication between two of the at least four chips respectively corresponding to two of the at least four nodes that are connected by each waveguide.

In some embodiments, the at least four chips include at least one of an electronic integrated circuit chip and a photonic integrated circuit chip.

In some embodiments, the at least four chips are each an electronic integrated circuit chip.

In some embodiments, the at least four chips are each a photonic integrated circuit chip.

In some embodiments, the electronic integrated circuit chip or the photonic integrated circuit chip is arranged at all nodes of the at least four nodes of the optical interconnection device. Alternatively, the electronic integrated circuit chips are arranged at some nodes of the at least four nodes of the optical interconnection device, and the photonic integrated circuit chips are arranged at the other nodes of the at least four nodes of the optical interconnection device.

In a third aspect, the present disclosure further provides a method for manufacturing an optical interconnection device, including:
providing a substrate; and
providing a plurality of waveguides on the substrate along a virtual closed path passing through at least four nodes, such that each waveguide optically connects two of the four nodes.

### BENEFICIAL EFFECTS

Some embodiments of the present disclosure at least have the following beneficial effects. In an optical network arrangement using the optical interconnection device(s) of these embodiments of the present disclosure, crossing between waveguides is avoided, the need for complex optical switching structures is eliminated, and interconnections between nodes is simplified. Additionally, in some embodiments, the coupling between the chip(s) and the optical interconnection device can have various types adaptable to different scenarios.

Various aspects, features, advantages, etc., of some embodiments of the present disclosure will be described in detail below with reference to the accompanying drawings. The above aspects, features, advantages, etc., of the present disclosure will become clearer from the following detailed description in conjunction with the accompanying drawings.

### BRIEF DESCRIPTION OF THE DRAWINGS

FIG. 1 is a side view of a chip package according to some exemplary embodiments of the present disclosure.

FIGS. 2 and 3 are top views of an optical interconnection device showing locations of nodes therein according to some exemplary embodiments of the present disclosure.

FIG. 4 illustrates an arrangement of waveguides for optical interconnection between nodes in an optical interconnection device according to some exemplary embodiments of the present disclosure.

FIG. 5 is a top view showing a waveguide arrangement for the nodes shown in FIG. 2.

FIG. 6 shows an exemplary structure of an optical transmitting portion and an optical receiving portion according to some exemplary embodiments of the present disclosure.

FIG. 7 shows a top view of another arrangement of waveguides for optical interconnection between nodes in an optical interconnect according to some other exemplary embodiments of the present disclosure.

FIG. 8 shows an exemplary virtual closed path for arranging waveguides in an optical interconnection device according to some exemplary embodiments of the present disclosure.

FIG. 9 shows another exemplary virtual closed path for arranging waveguides in an optical interconnection device according to some exemplary embodiments of the present disclosure.

### EMBODIMENTS OF THE INVENTION

Hereinafter, some embodiments will be described in more detail with reference to the accompanying drawings. However, the present disclosure may be embodied in various forms and should not be construed as limited to the embodiments shown herein. Rather, these embodiments are provided as examples, so that the present disclosure will be thorough and complete, and will fully convey the aspects and features of the present disclosure to those skilled in the art. Accordingly, processes, elements, and techniques, which are not necessary for one of ordinary skill in the art to fully understand the aspects and features of the present disclosure, may not be described. Unless otherwise stated, similar reference signs refer to similar elements throughout the drawings and description, and therefore, descriptions thereof may not be repeated. Additionally, features or aspects within each exemplary embodiment should be considered as applicable to other similar features or aspects in other exemplary embodiments.

Some terms may be used in the following description for reference purposes only and are not intended to be limiting. For example, the terms such as “top”, “bottom”, “upper”, “lower”, “above”, and “below” may be used to refer to directions in the figures as a reference. The terms such as “front”, “back”, “behind”, “side”, “outside”, and “inside” may be used to describe the orientation and/or position of each part of a component in a consistent but arbitrary reference coordinate system. The orientation and/or position of the part will be apparent from the text and associated drawings of the component discussed. Such terms may include the words specifically mentioned above, and their derivatives and synonyms. Similarly, numerical terms such as “first” and “second” referring to structures do not imply a sequence or an order unless the context clearly dictates otherwise.

It should be understood that when an element or feature is referred to as being “on”, “connected to”, or “coupled to” another element or layer, the element may be directly on or connected to another element or layer, or there may be one or more intermediate elements or features between these two elements. In addition, it will further be understood that when an element or feature is referred to as being “between” two elements or features, the element or feature may be the only element or feature between the two elements or features, or there are still one or more other intermediate elements or features.

The terminology used herein is for the purpose of describing particular embodiments and is not intended to be limiting the present disclosure. As used herein, the singular forms “a” and “an” are intended to include the plural forms as well, unless the context clearly indicates otherwise. Further, it should be understood that the terms “comprise”, “include”, and “have” when used in the description specify the presence of stated features, integers, steps, operations, elements, and/or parts, but do not exclude presence or addition of one or more other features, integers, steps, operations, elements, parts, and/or any combination thereof. As used herein, the term “and/or” includes any and all combinations of one or more of associated listed items. Expressions such as “at least one of” preceding a list of elements modify the entire list of elements, rather than individual elements of the list.

As used herein, the terms “substantially”, “approximately”, “about”, and similar terms are used to represent approximation rather than describing degree, and are intended to account for variations that one of ordinary skill in the art would recognize, e.g., measurements or inherent changes in calculated values. Additionally, “may” or “can” when used in describing embodiments of the present disclosure means “one or more embodiments of the present disclosure”. As used herein, the terms “use”, “being using”, and “being used” may be considered synonymous with the terms “utilize”, “being utilizing”, and “being utilized”, respectively.

Unless otherwise defined, all terms (including technical and scientific terms) used herein have the same meaning as commonly understood by one of ordinary skill in the art to which the present disclosure belongs. It should be understood that, unless expressly defined herein, terms (such as those defined in common dictionaries) are to be construed to have meanings consistent with their meaning in the relevant art and/or in the context of this specification, and should not be interpreted in an idealized or overly formal sense.

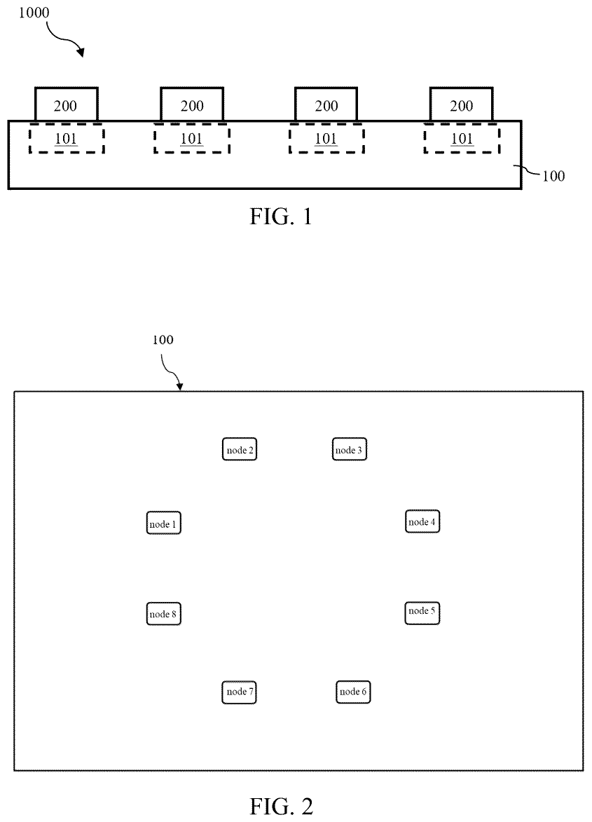

In an embodiment of the present disclosure, as shown in FIG. 1, a chip package 1000 includes an optical interconnection device 100 and a plurality of devices. The plurality of devices are optically connected through the optical interconnection device, so as to transmit data through the optical interconnection. In some embodiments, the plurality of devices may be multiple chips 200. The chips may be one or more selected from electronic integrated circuit (EIC) chips, photonic integrated circuit (PIC) chips, external devices, or other electronic or photonic devices. The optical interconnection device 100 includes at least four nodes 101 and a plurality of waveguides (not shown in FIG. 1). Each node is used to communicate with an external device. Each waveguide is used to optically connect two of the at least four nodes. The at least four chips 200 and the at least four nodes 101 have a one-to-one correspondence. Optionally, in some embodiments, the chip package may only include a plurality of EIC chips respectively corresponding to the nodes. In some embodiments, the chip package may only include a plurality of PIC chips respectively corresponding to the nodes.

In the exemplary embodiment, the chip package 1000 includes an optical interconnection device 100, and a plurality of chips 200. Each chip 200 is coupled to one node of the optical interconnection device 100. The plurality of chips and the at least four nodes have a one-to-one correspondence. The optical interconnection device 100 is configured to enable communication between two chips 200 respectively corresponding to two nodes 101 connected by each waveguide. In addition, in this article, the term “communication” should be interpreted broadly and may include two-way communication as well as one-way communication for example. Embodiments of the optical interconnection device applicable to the chip package are described below. For example, the optical interconnection device is a semiconductor optical interconnection device, which can be implemented by a photonic integrated circuit manufactured by semiconductor processes.

In some embodiments, the optical interconnection device includes at least four nodes and a plurality of waveguides. Each node is used to communicate with an external device. Each of the plurality of waveguides is used to optically connect two of the at least four nodes, such that the plurality of waveguides are arranged without crossing each other. In some embodiments, one of the EIC chip, the PIC chip, and other electronic or photonic devices may be arranged corresponding to each node. In some embodiments, the plurality of waveguides not crossing each other means that the plurality of waveguides do not cross each other in a same layer. The non-crossing arrangement of the waveguides include parallel arrangement of the waveguides, and may further include non-parallel arrangement of the waveguides.

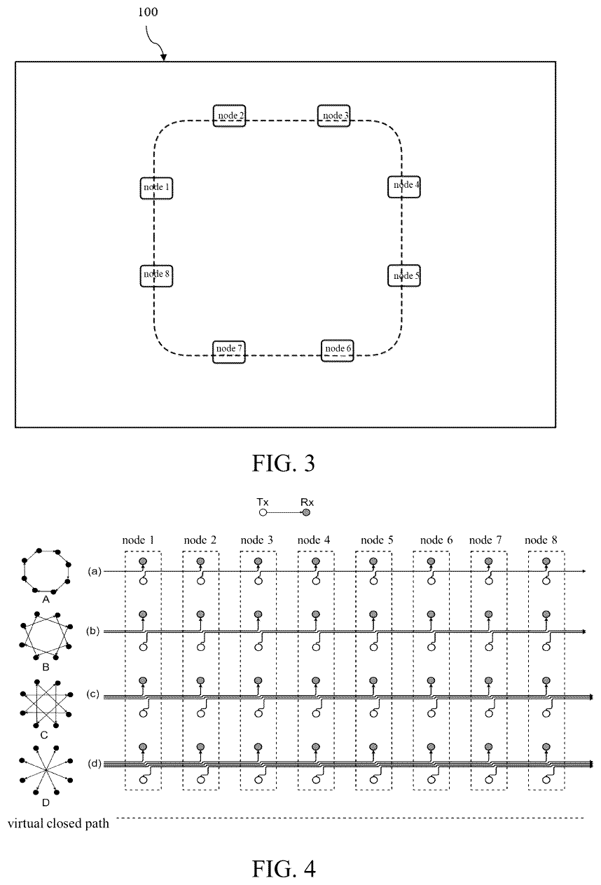

In some embodiments, a virtual closed path passing through the nodes of the optical interconnection device may be drawn, and the plurality of waveguides are distributed along the virtual closed path. In other words, the plurality of waveguides are arranged along the virtual closed path passing through the nodes of the optical interconnection device. The plurality of waveguides distributed along the virtual closed path includes those waveguides arranged near the virtual closed path, but not necessarily exactly overlapping the virtual closed path. In an exemplary embodiment, as shown in FIGS. 2-3, the optical interconnection device includes eight nodes, i.e., node 1 to node 8, and in the optical interconnection device, the waveguides (not shown in FIGS. 2-3) for optically connecting the nodes are distributed along a virtual closed path (shown as a dotted line in FIG. 3) that passes through the eight nodes.

FIG. 4 shows an example of an arrangement of the waveguides along the virtual closed path. For the sake of clarity, the virtual closed path shown in FIG. 3 is expanded in FIG. 4. In order to realize optical communication between the nodes, each node includes at least one of at least one optical transmitting portion and at least one optical receiving portion.

In some embodiments, among the nodes on the virtual closed path, two consecutively adjacent nodes are connected through a waveguide. Herein the two consecutively adjacent nodes are referred to as two first neighbouring nodes (e.g., first-order adjacent nodes), between which there is no other node. As shown in (a) in FIG. 4, an optical transmitting portion Tx of the node 1 is connected to an optical receiving portion Rx of the node 2 through a waveguide, so that information (or data) is sent from the node 1 to the node 2 in the form of an optical signal through the waveguide. An arrow drawn on the waveguide schematically indicates that the waveguide is directed from the optical transmitting portion of one node to the optical receiving portion of another node, and can also be understood as a propagation direction of the optical signal along the waveguide. The information may be provided by an EIC chip provided at the node 1, and the optical transmitting portion of the node 1 may include an electro-optical conversion unit to convert an electrical signal carrying the information provided by the EIC chip into an optical signal carrying the information. For example, the electro-optical conversion unit may include an electro-optical modulator. Optionally, the information may be provided by a PIC chip provided at the node 1, and the optical transmitting portion of the node 1 may include an optical coupler for coupling an optical signal carrying the information provided by the PIC chip. The optical receiving portion of the node 2 may include a photoelectric conversion unit, such as a photodetector (e.g., a photodiode) for converting a received optical signal into an electrical signal to be transmitted to an external EIC chip disposed at the node 2. Optionally, the optical receiving portion of the node 2 may include an optical coupler for coupling the received optical signal to the PIC chip provided at the node 2. In the present embodiments, the arrangement of the waveguides between every two consecutively adjacent nodes of the nodes 2 to 8, and the arrangement of the optical transmitting portions and the optical receiving portions of the nodes 2 to 8 are similar to the above-mentioned arrangement of the node 1 and the node 2, and thus will not be repeated here. In some embodiments, the node 8 and the node 1 are optically connected through a waveguide (for example, in (a) of FIG. 4, an arrow at the node 8 points to the node 1). Hence, the waveguide arranged along the virtual closed path optically connects the eight nodes 1 to 8 to form a topology of an optical network shown as A in FIG. 4. According to the above examples, an external device may be coupled to a corresponding node through optical signals or electrical signals. In some embodiments, a first type of chip may be coupled to a node through an optical signal to communicate with the node, and a second type of chip can be coupled to a node through an electrical signal to communicate with the node. The external device may include both the first type of chip and the second type of chip. For example, the optical interconnection device 100 realizes the interconnection between ten chips 200, of which four chips 200 are the first type of chips and six chips 200 are the second type of chips. In the embodiments of the present disclosure, the types of coupling between the chips and the optical interconnection device are various for applications to different scenarios.

It should be understood that the present disclosure is not limited to this. Different connection (or coupling) methods can be used between the nodes to form different topological structures. Examples will be described below with reference to (b), (c), and (d) in FIG. 4.

In some embodiments, among the nodes on the virtual closed path, two second neighbouring nodes (e.g., second-order adjacent nodes) are connected by a waveguide. Herein the two second neighbouring nodes refer to two nodes that are separated by one node, that is, there is one node between the two nodes. As shown in (b) of FIG. 4, the optical transmitting portion Tx of the node 1 and the optical receiving portion Rx of the node 3 are connected through a waveguide, so that information (or data) is sent from the node 1 to the node 3 in the form of an optical signal through the waveguide. The information may be provided by an EIC chip that is provided at the node 1, and the optical transmitting portion of the node 1 may include an electro-optical conversion unit to convert an electrical signal carrying the information provided by the EIC chip into an optical signal carrying the information. For example, the electro-optical conversion unit may include an electro-optical modulator. Optionally, the information may be provided by a PIC chip provided at the node 1, and the optical transmitting portion of the node 1 may include an optical coupler for coupling an optical signal carrying the information provided by the PIC chip. The optical receiving portion of the node 3 may include a photoelectric conversion unit, such as a photodetector (e.g., a photodiode), for converting the received optical signal into an electrical signal, which is to be transmitted to an EIC chip provided at the node 3. Optionally, the optical receiving portion of the node 3 may include an optical coupler for coupling the received optical signal to a PIC chip provided at the node 3. Similar connections may be established, through respective waveguides, between the following pairs: the node 2 and the node 4, the node 3 and the node 5, the node 4 and the node 6, the node 5 and the node 7, the node 6 and the node 8, the node 7 and the node 1 (an arrow at the node 7 in the figure points to the node 1), and the node 8 and the node 2 (an arrow at the node 8 in the figure points to the node 2). These waveguides do not cross each other. Therefore, the multiple waveguides arranged along the virtual closed path optically connect the eight nodes 1 to 8 to form a topology of an optical network shown as B in FIG. 4. For example, each node is configured to be connected to its corresponding second neighbouring node.

In some embodiments, among the nodes on the virtual closed path, two third neighbouring nodes (e.g., third-order adjacent nodes) are connected by a waveguide. Herein the two third neighbouring nodes refer to two nodes that are separated by two nodes, that is, there are two nodes between the two nodes. As shown in (c) of FIG. 4, the optical transmitting portion Tx of the node 1 and the optical receiving portion Rx of the node 4 are connected through a waveguide, so that information (or data) is sent from the node 1 to the node 4 in the form of an optical signal through the waveguide. The information may be provided by an EIC chip provided at the node 1, and the optical transmitting portion of the node 1 may include an electro-optical conversion unit to convert an electrical signal carrying the information provided by the EIC chip into an optical signal carrying the information. For example, the electro-optical conversion unit may include an electro-optical modulator. Optionally, the information may be provided by a PIC chip provided at the node 1, and the optical transmitting portion of the node 1 may be an optical coupler for coupling an optical signal carrying the information provided by the PIC chip. The optical receiving portion of the node 4 may include a photoelectric conversion unit, such as a photodetector (e.g., a photodiode), for converting the received optical signal into an electrical signal which is to be transmitted to an EIC chip provided at the node 4. Optionally, the optical receiving portion of the node 4 may be an optical coupler for coupling the received optical signal to a PIC chip provided at the node 4. Similar connections may be established, through respective waveguides, between the following pairs: the node 2 and the node 5, the node 3 and the node 6, the node 4 and the node 7, the node 5 and the node 8, the node 6 and the node 1 (an arrow at the node 6 in the figure points to the node 1), the node 7 and the node 2 (an arrow at the node 7 in the figure points to the node 2) , the node 8 and the node 3 (an arrow at the node 8 in the figure points to the node 3). These waveguides do not cross each other. Therefore, the multiple waveguides arranged along the virtual closed path optically connect the eight nodes 1 to 8 to form a topology of an optical network shown as C in FIG. 4.

In some embodiments, among the nodes on the virtual closed path, two fourth neighbouring nodes (e.g., fourth-order adjacent nodes) are connected by a waveguide. In this article, the two fourth neighbouring nodes refer to two nodes that are separated by three nodes, that is, there are three nodes between the two nodes. As shown in (d) of FIG. 4, the optical transmitting portion Tx of the node 1 and the optical receiving portion Rx of the node 5 are connected through a waveguide, so that information (or data) is sent from the node 1 to the node 5 in the form of an optical signal through the waveguide. The information may be provided by an EIC chip provided at the node 1, and the optical transmitting portion of the node 1 may include an electro-optical conversion unit to convert an electrical signal carrying the information provided by the EIC chip into an optical signal carrying the information. For example, the electro-optical conversion unit may include an electro-optical modulator. Optionally, the information may be provided by a PIC chip provided at the node 1, and the optical transmitting portion of the node 1 may include an optical coupler for coupling an optical signal carrying the information provided by the PIC chip. The optical receiving portion of the node 5 may include a photoelectric conversion unit, such as a photodetector (e.g., a photodiode), for converting the received optical signal into an electrical signal which is to be transmitted to an EIC chip provided at the node 5. Optionally, the optical receiving portion of the node 5 may be an optical coupler for coupling the received optical signal to a PIC chip provided at the node 5. Similar connections may be established, through respective waveguides, between the following pairs: the node 2 and the node 6, the node 3 and the node 7, the node 4 and the node 8. These waveguides do not cross each other. Therefore, the multiple waveguides arranged along the virtual closed path optically connect the eight nodes 1 to 8 to form a topology of an optical network shown as D in FIG. 4.

In some embodiments, the plurality of waveguides are configured that any two nodes of the at least four nodes are connected. For example, the structures shown in (a), (b), (c), and (d) in FIG. 4 can be combined, which is sufficient to form a topology in which any two nodes are interconnected, and two-way communication can be achieved between two of the at least four nodes. For example, in (d) of FIG. 4, the transmitting portion Tx of the node 1 can transmit a signal to the node 5 through a waveguide, and the node 5 can transmit a signal to the node 1 through another waveguide. However, in the overall scheme of FIG. 4, that is, in a combination of (a), (b), (c), and (d) of FIG. 4, no two-way communication is realized between any pair of the nodes. For example, the node 3 can transmit information to the node 4 through the waveguide (already shown in (a) of FIG. 4), but the node 4 is not configured to send information to the node 3, and such communication is one-way communication. Based on FIG. 4, in order to achieve two-way communication between any two nodes, an appropriate number of additional waveguides can be configured, such as by arranging some additional waveguides along the virtual closed path and arranging appropriate transmitting/receiving portions in the nodes.

In some embodiments, as shown in FIG. 6, the optical transmitting portion Tx of one node includes an electro-optical modulator 501 used to modulate information carried by an electrical signal, which is transmitted through a conductive line 502, into an optical signal. The transmitting portion Tx is further used to send the optical signal to a waveguide 503, and the optical signal is transmitted to an optical receiving portion Rx of another node through the waveguide 503, so that the optical receiving portion Rx receives the optical signal carrying the information through the waveguide 503. The optical receiving portion Rx may include an optical detector 504 for converting the received optical signal into an electrical signal, and the electrical signal is output via another conductive line 505.

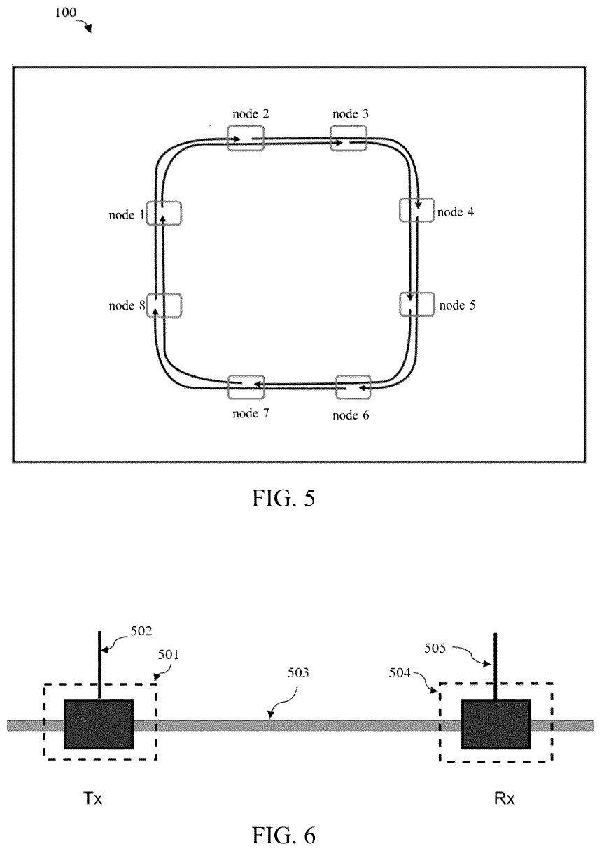

FIG. 5 shows an arrangement of the waveguides for the nodes shown in FIG. 2, which realizes connection between each node and its second neighbouring node. It can be considered that these waveguides are arranged along the virtual closed path as shown in FIG. 3. For example, the waveguides in FIG. 5 are curved waveguides. In some embodiments, the curved waveguides can be more suitable to follow the virtual closed path. At least three curved waveguides can be configured, which is suitable for more complex connections. A shape of the virtual closed path is not particularly limited. An arrangement of the waveguides can be considered to be consistent with the concept of the present disclosure as long as the waveguides are arranged along the virtual closed path. The arrangement of the waveguides in FIG. 5, after being expanded along the virtual closed path, presents a situation as shown in (b) of FIG. 4. In this embodiment, each of the at least four nodes is configured to be connected to its second neighbouring node.

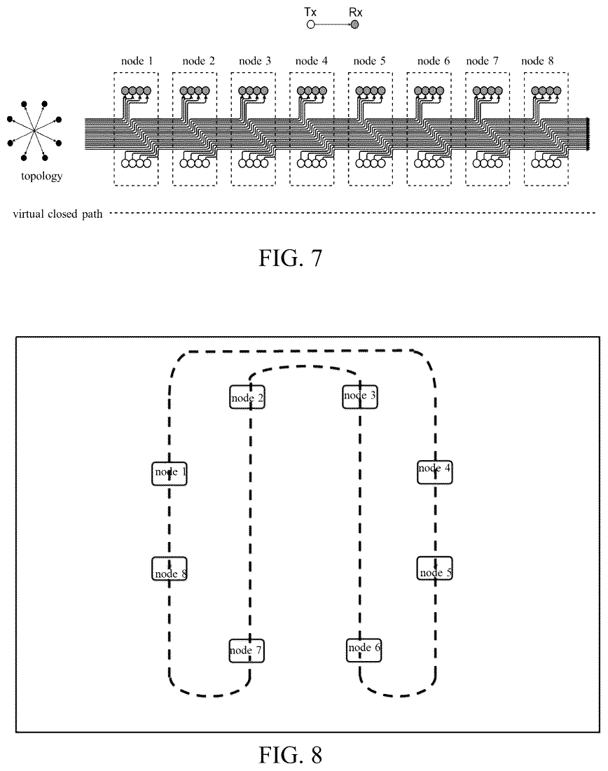

In some embodiments, a waveguide connecting two nodes is a single channel. For example, as shown in FIG. 4, two optically connected nodes each have one optical transmitting portion and one optical receiving portion. As shown in (d) of FIG. 4, in the optical interconnection configuration where each of the eight nodes is connected to its fourth neighbouring node through a single waveguide, a total of four parallel waveguides are provided along the virtual closed path, and the four waveguides do not cross each other. In some other embodiments, two optically connected nodes may be connected through multi channels. For example, as shown in FIG. 7, four waveguides are used to connect four optical transmitting portions of the node 1 and four optical receiving portions of the node 5 respectively, which can provide a larger transmitting bandwidth. Moreover, as shown in the topology of FIG. 7, the eight nodes arranged along the virtual closed path adopt a configuration in which the two fourth neighbouring nodes are optically connected to each other, parallel waveguides are provided along the virtual closed path, and these waveguides do not cross each other. In the embodiment shown in FIG. 3, the waveguides for optical interconnection are provided along an approximately O-shaped circular virtual path passing through the eight nodes. It should be understood that the present disclosure is not limited to this, and the virtual closed path may further have other forms. For example, along the virtual closed path shown by a dotted line in FIG. 8, the waveguides for optical interconnection may also be arranged without crossing each other. It should be understood that the eight nodes are used as an example in the above description, while the number of nodes in the optical interconnection device of the present disclosure is not limited and can be greater than or less than eight.

In some embodiments, the optical interconnection device includes a plurality of nodes and a plurality of waveguides distributed along a virtual closed path passing through the plurality of nodes, such that the plurality of waveguides are arranged in a manner that prevents the waveguides from crossing each other. The plurality of nodes includes a first node and a second node, and a waveguide connecting the first node and the second node is arranged so as to not cross other waveguide connecting any other pair of nodes. For example, the waveguide for optically connecting the node 1 (as the first node) and the node 3 (as the second node) does not cross other waveguides each for optically connecting any other pair of nodes (the waveguides are not shown in FIG. 3). Alternatively, the waveguide for optically connecting the node 1 (as the first node) and the node 5 (as the second node) does not cross other waveguides each for optically connecting any other pair of nodes. Alternatively, the waveguide for optically connecting the node 1 (as the first node) and the node 6 (as the second node) does not cross other waveguides each for optically connecting any other pair of nodes.

In some embodiments, the plurality of nodes includes a first node and a second node, the first node is adjacent to the second node, and a waveguide connecting the first node and the second node does not cross other waveguides each for optically connecting any other pair of nodes. For the nodes arranged in FIG. 3 (the waveguides are not shown in FIG. 3), the waveguide for optically connecting the node 1 (as the first node) and the node 2 (as the second node) does not cross other waveguides each for optically connecting any other pair of nodes.

In some embodiments, the plurality of nodes includes a first node and a second node, and there are N nodes between the first node and the second node, where N≥1. Furthermore, the waveguide connecting the first node and the second node does not cross the other waveguides each for optically connecting any other pair of nodes. For example, for the nodes arranged in FIG. 3 (the waveguides are not shown in FIG. 3), the waveguide for optically connecting the node 1 (as the first node) and the node 3 (as the second node) does not cross other waveguides each for optically connecting any other pair of nodes. Alternatively, the waveguide for optically connecting the node 1 (as the first node) and the node 4 (as the second node) does not cross other waveguides each for optically connecting any other pair of nodes. Alternatively, the waveguide for optically connecting the node 1 (as the first node) and the node 5 (as the second node) does not cross other waveguides each for optically connecting any other pair of nodes.

In some embodiments, the plurality of nodes includes consecutively adjacent first node, second node, third node, and fourth node. A waveguide connecting the first node to the second node, another waveguide connecting the first node to the third node, and still another waveguide connecting the first node to the fourth node do not cross each other. For example, for the nodes arranged in FIG. 3 (the waveguides are not shown in FIG. 3), the waveguide connecting the node 1 and the node 2, the waveguide connecting the node 1 and the node 3, and the waveguide connecting the node 1 and the node 4 do not cross each other. In some embodiments, a waveguide connecting the first node to the third node does not cross another waveguide connecting the second node to the fourth node. For example, the waveguide connecting the node 1 to the node 3 does not cross the waveguide connecting the node 2 to the node 4. In some embodiments, a waveguide connecting the first node to the fourth node does not cross another waveguide connecting the second node to the third node. For example, the waveguide connecting the node 1 to the node 4 does not cross the waveguide connecting the node 2 to the node 3.

In some embodiments, the plurality of nodes includes consecutively adjacent first node, second node, third node, fourth node, and fifth node. A waveguide connecting the first node to the fourth node does not cross a waveguide connecting the second node to the fifth node. For example, for the node arrangement in FIG. 3 (the waveguides are not shown in FIG. 3), the waveguide connecting the node 1 to the node 4 does not cross the waveguide connecting the node 2 to the node 5.

In some embodiments, the optical interconnection device includes a plurality of nodes and a plurality of waveguides. The plurality of waveguides are arranged along any virtual closed path passing through the plurality of nodes. One of the plurality of nodes is used as a starting node. Waveguides each connecting the starting node to one of other nodes are different from each other and do not cross each other. For example, taking the eight nodes shown in FIG. 3 as an example, the node 1 is the starting node, and the waveguides (not shown in FIG. 3) respectively connecting the node 1 to the nodes 2 to 8 are different from each other, and do not cross each other. In some embodiments, a plurality of optical transmitting portions of the starting node are respectively connected to optical receiving portions of other nodes through different waveguides in a same direction along the virtual closed path. For example, the node 1 includes seven optical transmitting portions. In order to respectively connect the seven transmitting portions of the node 1 to the receiving portions of the seven other nodes, the node 1 may be taken as the starting node, and each of the seven optical transmitting portions of the node 1 may be connected to the optical receiving portion of each of the nodes 2 to 8 through a corresponding waveguide in a clockwise or counterclockwise direction along the virtual closed path in FIG. 3, so that the waveguides for respectively connecting the seven transmitting portions of the node 1 and the receiving portions of the nodes 2 to 8 do not cross each other. FIG. 3 only shows the positions of the nodes, but does not show the optical transmitting portions, the optical receiving portions, or the waveguides. In some embodiments, a plurality of optical transmitting portions of the starting node are respectively connected to the optical receiving portions corresponding to some nodes of the plurality of nodes through different waveguides in a first direction along the virtual closed path, and to the optical receiving portions corresponding to other nodes of the plurality of nodes through other different waveguides in a second direction along the virtual closed path, wherein the second direction is opposite to the first direction. For example, the node 1 includes seven transmitting portions. In order to connect the seven transmitting portions of the node 1 to the receiving portions of the other seven nodes, the node 1 may be taken as the starting node, four of the seven optical transmitting portions of the node 1 may be respectively connected to the optical receiving portions of the nodes 2 to 5 through different waveguides along the virtual closed path in FIG. 3 in a clockwise direction, and the other three of the seven optical transmitting portions of the node 1 may be respectively connected to the optical receiving portions of the nodes 6 to 8 through different waveguides along the virtual closed path in FIG. 3 in a counterclockwise direction. In the above embodiments, the node 1 can be used as the starting node, and each of the plurality of transmitting portions of the node 1 is connected to one receiving portion of a corresponding one of the other nodes, so that the node 1 can send optical signals to the other nodes.

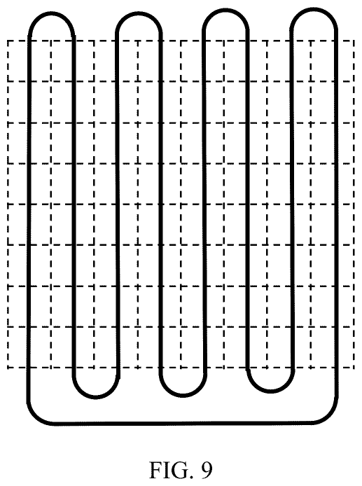

In some embodiments, the optical interconnection device includes a plurality of nodes arranged in an array and a plurality of waveguides, the virtual closed path extends along columns or rows of the array, and the plurality of waveguides are arranged along the virtual closed path. As shown in FIGS. 9, 64 nodes are arranged in an 8×8 array. The virtual closed path (shown by a solid line in FIG. 9) extends up and down along the columns of the array, and the plurality of waveguides are arranged along the virtual closed path.

In some other embodiments of the present disclosure, a method for manufacturing an optical interconnection device is provided, including:
providing a substrate; and
providing a plurality of waveguides on the substrate along a virtual closed path passing through at least a plurality of nodes, such that each waveguide optically connects two nodes of the plurality of nodes.

The present disclosure does not limit the order of determining the virtual closed path, providing the nodes, and providing the waveguides.

In some embodiments, the virtual closed path passing through the plurality of nodes may be determined based on the plurality of nodes provided on the substrate, and then the waveguides for optical interconnection may be arranged along the virtual closed path, such that the waveguides do not cross each other.

In some embodiments, the plurality of nodes, the closed paths passing through the plurality of nodes, and the plurality of waveguides arranged along the closed paths may be stored as pattern data in advance, and in a semiconductor manufacturing process, nodes and waveguides may be formed on a substrate based on the stored pattern data.

It should be understood by those skilled in the art that what is disclosed above is merely some implementations and should not be construed as limiting the scope of the patent protection claimed in the present disclosure. Any equivalent modifications or variations based on these implementations are intended to fall within the scope of the claims of the present disclosure.

1. An optical interconnection device, comprising:
at least four nodes, wherein each node is configured to communicate with an external device; and
a plurality of waveguides, wherein each waveguide is configured to optically connect two of the at least four nodes.

2. The optical interconnection device of claim 1, wherein the plurality of waveguides are arranged along a virtual closed path passing through the at least four nodes, such that the plurality of waveguides do not cross each other.

3. The optical interconnection device of claim 2, wherein each node comprises at least one of one or more optical transmitting portions and one or more optical receiving portions.

4. The optical interconnection device of claim 3, wherein each waveguide is configured to connect one of the one or more optical transmitting portions of one of the at least four nodes to one of the one or more optical receiving portions of another of the at least four nodes, so as to transmit an optical signal from the optical transmitting portion of the one node to the optical receiving portion of the another node.

5. The optical interconnection device of claim 4, wherein the at least four nodes comprise a first node and a second node, and the plurality of waveguides comprises a waveguide for connecting the first node and the second node.

6. The optical interconnection device of claim 5, wherein along the virtual closed path, the first node is adjacent to the second node, or
along the virtual closed path, there are N other nodes of the at least four nodes between the first node and the second node, wherein N>1.

7. (canceled)

8. The optical interconnection device of claim 4, wherein along the virtual closed path, the at least four nodes comprise consecutively adjacent first node, second node, third node, and fourth node, and
the plurality of waveguides comprise a waveguide connecting the first node to the second node, a waveguide connecting the first node to the third node, and a waveguide connecting the first node to the fourth node.

9. The optical interconnection device of claim 4, wherein along the virtual closed path, the at least four nodes comprise consecutively adjacent first node, second node, third node, and fourth node, and
the plurality of waveguides comprise a waveguide connecting the first node to the third node, and a waveguide connecting the second node to the fourth node.

10. The optical interconnection device of claim 4, wherein along the virtual closed path, the at least four nodes comprise consecutively adjacent first node, second node, third node, and fourth node, and
the plurality of waveguides comprise a waveguide connecting the first node to the fourth node, and a waveguide connecting the second node to the third node.

11. The optical interconnection device of claim 4, wherein along the virtual closed path, the at least four nodes comprise consecutively adjacent first node, second node, third node, fourth node, and fifth node, and
the plurality of waveguides comprise a waveguide connecting the first node to the fourth node, and a waveguide connecting the second node to the fifth node.

12. The optical interconnection device of claim 4, wherein the at least four nodes comprise a starting node, and the plurality of waveguides are configured to connect the starting node to each of other nodes of the at least four nodes, wherein:
the starting node comprises the optical transmitting portions, which are respectively connected to a corresponding one of the one or more optical receiving portions of each of the other nodes through different ones of the plurality of waveguides along the virtual closed path in a same direction, or
the starting node comprises the optical transmitting portions, some of which are respectively connected to a corresponding one of the one or more optical receiving portions of each of some of the other nodes through different ones of the plurality of waveguides along the virtual closed path in a first direction, and remaining of which are connected to a corresponding one of the one or more optical receiving portions of each of remaining nodes of the other nodes through other different ones of the plurality of waveguides along the virtual closed path in a second direction, wherein the second direction is opposite to the first direction.

13. (canceled)

14. (canceled)

15. The optical interconnection device of claim 4, wherein the at least four nodes are arranged in an array, the virtual closed path extends along columns or rows of the array, and the plurality of waveguides are arranged along the virtual closed path.

16. The optical interconnection device of claim 4, wherein each of the at least four nodes is configured to be connected to a second neighbouring node thereof.

17. The optical interconnection device of claim 1, wherein each node comprises at least one of one or more optical transmitting portions and one or more optical receiving portions, and
each waveguide is configured to connect a corresponding one of the one or more optical transmitting portions of one of the at least four nodes to a corresponding one of the one or more optical receiving portions of another of the at least four nodes, so as to transmit an optical signal from the optical transmitting portion of the one node to the optical receiving portion of the another node.

18. (canceled)

19. The optical interconnection device of claim 14, wherein each optical transmitting portion comprises an electro-optical conversion unit, and each optical receiving portion comprises a photoelectric conversion unit.

20. The optical interconnection device of claim 1, wherein the plurality of waveguides comprise a curved waveguide.

21. The optical interconnection device of claim 1, wherein the plurality of waveguides are configured such that any two of the at least four nodes are connected.

22. A chip package, comprising:
an optical interconnection device, comprising:
at least four nodes, wherein each node is configured to communicate with an external device, and
a plurality of waveguides, wherein each waveguide is configured to optically connect two of the at least four nodes; and
at least four chips, wherein each chip is coupled to a corresponding one of the at least four nodes of the optical interconnection device, and the at least four chips and the at least four nodes have a one-to-one correspondence,
wherein the optical interconnection device is configured to enable communication between two of the at least four chips respectively corresponding to two of the at least four nodes that are connected by each waveguide.

23. The chip package of claim 22, wherein the at least four chips comprise at least one of an electronic integrated circuit chip and a photonic integrated circuit chip.

24. (canceled)

25. (canceled)

26. A method for manufacturing an optical interconnection device, comprising:
providing a substrate; and
providing a plurality of waveguides on the substrate along a virtual closed path passing through at least four nodes, such that each waveguide optically connects two of the four nodes.
